(19) United States
(12) Patent Application Publication
(10) Pub. No.: US 2009/0255333 A1
(43) Pub. Date: Oct. 15, 2009

(54) MEASURING CUP

(76) Inventors: Lou HENRY, Woodridge, IL (US); Chris Mellen, Woodridge, IL (US); Jennifer Courington, Woodridge, IL (US)

Correspondence Address: MCGUIREWOODS, LLP, 1750 TYSONS BLVD, SUITE 1800, MCLEAN, VA, 22102, US

(21) Appl. No.: 12/404,641

(22) Filed: Mar. 16, 2009

Related U.S. Application Data
(60) Provisional application No. 61/036,941, filed on Mar. 15, 2008.

(51) Int. Cl. G01F 19/00; B65D 85/00

(52) U.S. Cl. 73/427; 206/459.1; 206/459.5; 73/426

(57) ABSTRACT

A measuring cup includes a wall structure surrounding a holding space to hold contents, an opening exposing the holding space, and a surface pattern provided on the wall structure. The surface pattern includes a plurality of concave patterns superposed on each other. Each concave pattern is vertically concave such that edges therebetween are protruded to form a plurality of first visually observable lines indicative of a first set of predetermined volumes within the holding space.

### CROSS REFERENCE TO PRIOR APPLICATIONS

This application claims priority under 35 U.S.C. § 119(e) and the benefits thereof from a U.S. Provisional Application Ser. No. 61/036,941 filed on Mar. 15, 2008, which is hereby incorporated by reference for all purposes as if fully set forth herein.

### BACKGROUND

1. Field

The disclosure is directed to a measuring cup, and more particularly, to a measuring cup with a surface pattern indicating predetermined volumes within a holding space of the measuring cup.

2. Related Art

A measuring cup is typically provided with volumetric indicia on the measuring cup's wall such that a user may recognize the volume of contents contained within the measuring cup. Traditional measuring cups have the indicia marked upon the measuring cup wall in such a manner that makes the indicia difficult to read. This effects how precise a measurement is. For those measuring cups, the most precise way to measure the contents contained therein is to place the measuring cup upon a level surface, pour the contents to be measured into the measuring cup and then stoop down to the vertical level of the measuring cup to attempt to visually detect the bottom of a liquid meniscus or to a level surface of solid contents. This pour and stoop process is repeated until the correct amount has been achieved. This approach can be slow and/or bothersome.

An alternative method is to read the level to which contents in a transparent or translucent measuring cup have risen is to lift the measuring cup to eye level and attempt to hold the measuring cup steady while visually detecting the volume. This approach can be less accurate. In either case, the observer is required to look in a generally horizontal direction to detect the volume.

Opaque (i.e., non-transparent) measuring cups are even more difficult to read than transparent or translucent measuring cups. In order to read the volume of contents held within an opaque measuring cup, a user must peer over and into the measuring cup to eyeball, as closely as possible, the level to which contents have risen, either by stooping to the measuring cup's level or by lifting the measuring cup to eye level. This is difficult and results again in less accuracy.

While the above-described approaches for determining the volume of contents in a measuring cup may seem simple enough for most users, these methods can prove to be difficult for others. Users with bad knees, a bad back, or arthritis, for example, may not only have substantial difficulty in stooping over to accurately read the volume of contents in a measuring cup placed on a level surface, but may also have just as much difficulty in lifting a measuring cup to eye level and holding the cup steady to read the volume of contents held therein. When precise measurement of the volume of contents within a measuring cup is a critical task, the simple actions of bending over or lifting a measuring cup to eye level, which seem easy to some users, may become difficult and uncomfortable for others.

Measuring the volume of cooking ingredients using prior art measuring cups can also be frustrating. As mentioned above, it can be difficult for a user to stoop over to read the level of contents when placed on a level surface or when lifted to eye level. An unsteady hand not only makes the volume of contents difficult to determine when a measuring cup is lifted to eye level, but a user may spill contents or even drop the measuring cup when attempting to do so, not to mention tip the measuring cup resulting in inaccurate measurement.

Measuring cups are not limited in their utility to the kitchen, of course. They may also be used for measuring proper ratios of solutions, e.g., antifreeze, the precise measurement of which is critical to its application and simplicity of determining a precise volume is necessary. Other common household solutions can be dangerous, e.g., toxic or caustic, and when a measuring cup is filled with these solutions, the possibility of spilling them within the proximity of a child or a pet greatly increases when a measuring cup must be raised to eye level to determine the volume of its contents.

Thus, there is a need for a measuring cup that is easier and more accurate to use when measuring a volume of contents contained therein.

### SUMMARY OF THE DISCLOSURE

According to an aspect of the disclosure, a measuring cup includes a wall structure surrounding a holding space to hold contents, an opening exposing the holding space, and a surface pattern provided on the wall structure and including a plurality of concave patterns superposed on each other. Each concave pattern is vertically concave such that edges therebetween are protruded to form a plurality of first visually observable lines indicative of a first set of predetermined volumes within the holding space.

The wall structure may include a bottom wall having inner and outer surfaces and a sidewall extending upwardly from a circumference of the bottom wall and having inner and outer surfaces. The holding space may be defined by the inner surfaces of the bottom wall and the sidewall. The surface pattern may at least partially occupy the sidewall. The plurality of concave patterns may occupy a portion of the inner surface of the sidewall in the front portion of the measuring cup.

The surface pattern may further includes a plurality of convex patterns. Each convex pattern may be vertically convex such that edges therebetween may be recessed to form a plurality of second visually observable lines indicative of a second set of predetermined volumes, respectively, within the holding space. The plurality of convex patterns may occupy a portion of the outer surface of the sidewall in the front portion of the measuring cup. The first and second sets of predetermined volumes may be identical. Each concave pattern may be horizontally curved in at a center thereof, and each convex pattern may be horizontally curved out at a center thereof.

The measuring cup may further include a spout provided on a front portion of the measuring cup and projecting outwardly from an upper end of the sidewall and a handle provided on a rear portion of the measuring cup and connected to the sidewall.

The measuring cup may further include indicia indicating the first set of predetermined volumes. The indicia may include a first set of alphanumeric characters positioned adjacent to the plurality of first visually observable lines, respectively. The indicia may further include at least one marking spaced between the plurality of first visually observable lines to indicate a predetermined volume between the first set of predetermined volumes and at least one second set of alphanumeric characters positioned adjacent to the at least one marking to indicate the predetermined volume thereof.

According to another aspect of the disclosure, a measuring cup includes a wall structure defining a holding space for containing contents, an opening exposing the holding space, and a surface pattern at least partially occupying the wall structure and including either or both of a concave pattern group and a convex pattern group. The concave pattern group includes a plurality of concave patterns arranged on each other. Each concave pattern is vertically concave such that edges therebetween are protruded to form a plurality of first visually observable lines indicative of a first set of predetermined volumes, respectively, within the holding space. The convex pattern group includes a plurality of convex patterns arranged on each other. Each convex pattern is vertically convex such that edges therebetween are recessed to form a plurality of second visually observable lines indicative of a second set of predetermined volumes, respectively, within the holding space.

The wall structure may include a bottom wall having inner and outer surfaces, and a sidewall expending upwardly from a circumference of the bottom wall and having inner and outer surfaces. The holding space may be defined by the inner surfaces of the bottom wall and the sidewall.

The surface pattern may at least partially occupy a front portion of the measuring cup. The concave pattern group may occupy the inner surface of the sidewall in the front portion of the measuring cup. The convex pattern group may occupy the outer surface of the sidewall in the front portion of the measuring cup.

The measuring cup may further include a spout provided in the front portion of the measuring cup and projecting outwardly from an upper end of the sidewall, and a handle provided on a rear portion of the measuring cup and connected to the sidewall.

The measuring cup may further include indicia positioned adjacent to at least one of the first and second sets of predetermined volumes. The first and second sets of the predetermined volumes may be identical.

Additional features, advantages, and embodiments of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows a perspective view of a measuring cup constructed according to the principles of the disclosure;

FIG. 2 shows a top view of the measuring cup shown in FIG. 1;

FIG. 3 shows a side view of the measuring cup shown in FIG. 1;

FIG. 4 shows a front view of the measuring cup shown in FIG. 1;

FIG. 5 shows a bottom side perspective view of the measuring cup shown in FIG. 1 with volumetric indicia; and

FIG. 6 shows a side view of the measuring cup shown in FIG. 1 with volumetric indicia.

### DETAILED DESCRIPTION

The embodiments of the disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

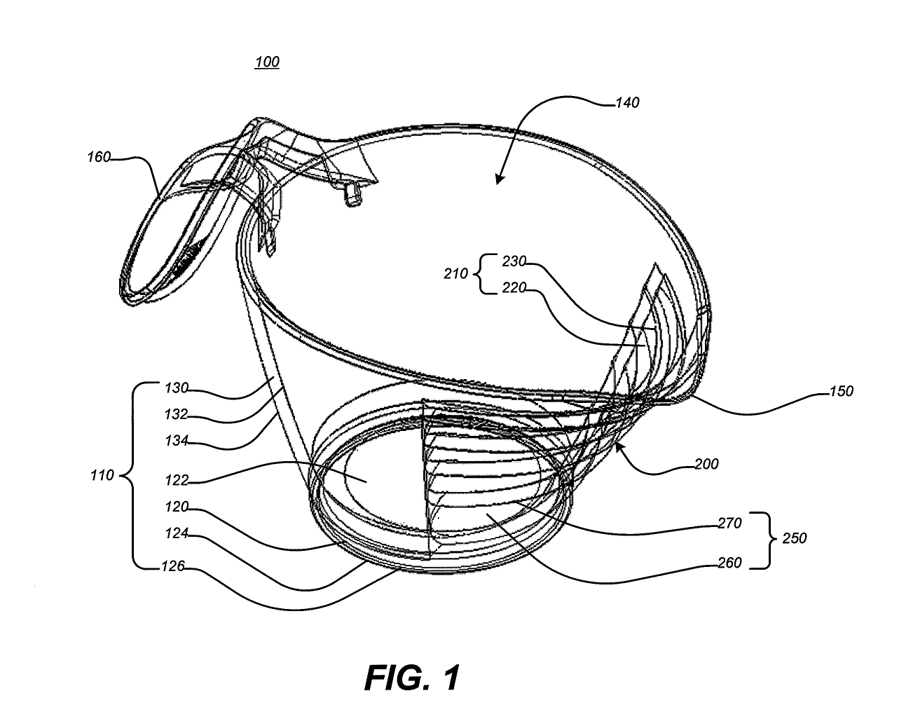

FIG. 1 shows a perspective view of a measuring cup 100 constructed according to the principles of the disclosure. The measuring cup 100 may include a wall structure 110, an opening 140, a spout 150, a handle 160, a surface pattern 200 and/or the like. The measuring cup 100 may be at least partially transparent or translucent such that the content contained therein may be visible through the wall structure 110. However, the wall structure 110 may be alternatively opaque.

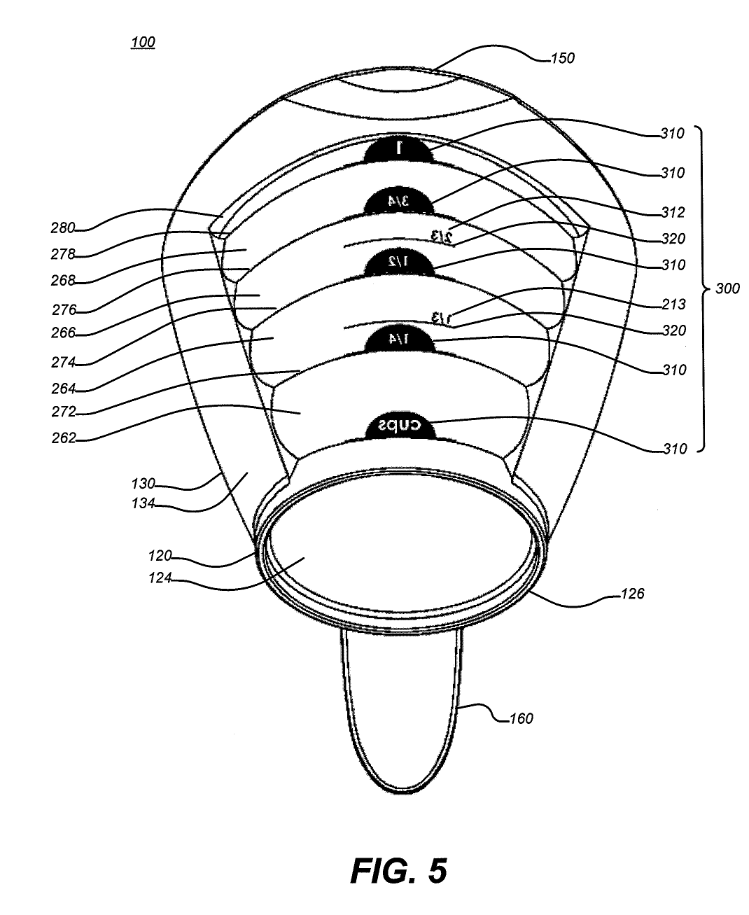

The wall structure 110 may include a bottom wall 120, a sidewall 130 and/or the like. The bottom wall may have an inner surface 122 and an outer surface 124. The inner and/or outer surfaces 122, 124 of the bottom wall 120 may be substantially flat and/or have a circular shape. Any different geometry and/or shape for the bottom wall 120 is contemplated in accordance with the disclosure. The bottom wall 120 may include a rim 126 (shown in FIG. 5) encircling and extending downwardly from the outer surface 124 of the bottom wall 120.

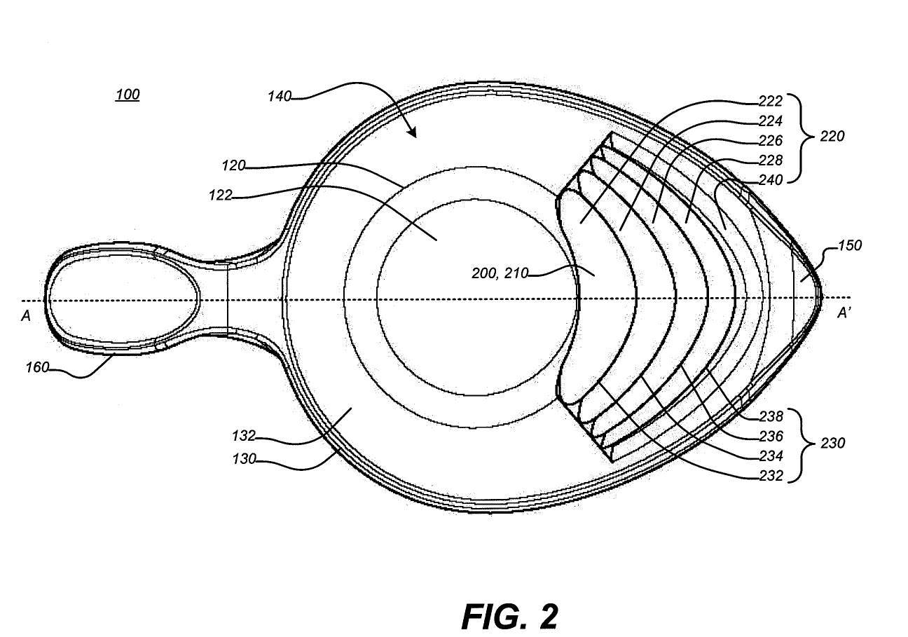

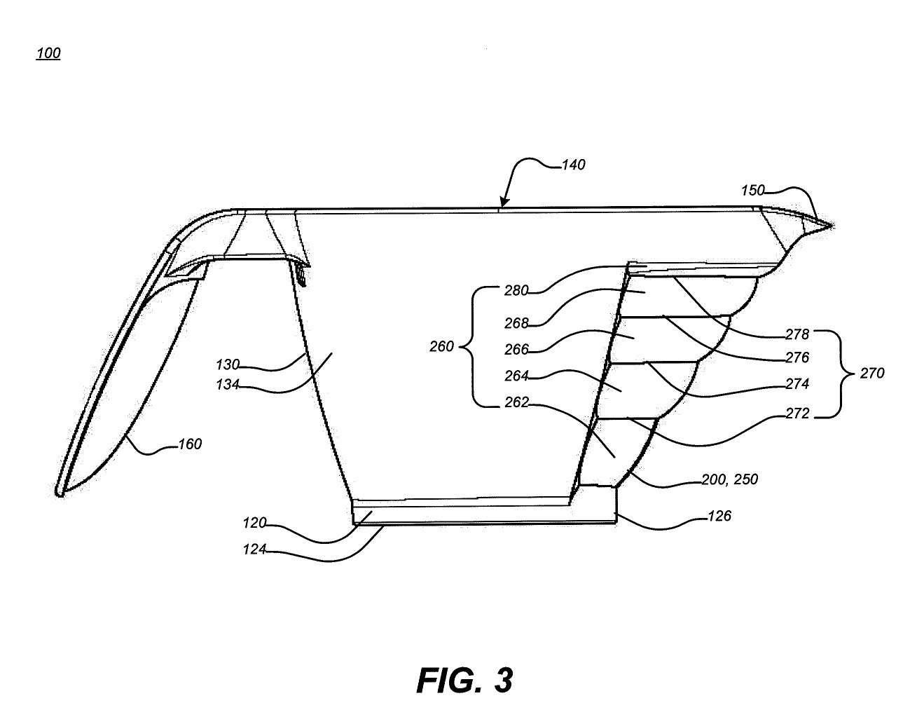

The sidewall 130 may encircle the bottom wall 120 and extend upwardly from a circumference of the bottom wall 120. The sidewall 130 may have a generally trapezoid shape when viewed from the sides (cross-section) thereof as shown in FIGS. 3, 4 and 6. A different configuration for the sidewall 130 is also contemplated, such as, for example, a cubic, triangular, cylindrical shape or the like. An upper edge of the sidewall 130 may define the opening 140 which exposes a holding space of the measuring cup 100. The opening 140 may have an oval or tear-drop shape (shown in FIG. 2) but a different shape is also contemplated for the opening 140, including, for example, circular, triangular, rectangular, square, octagonal, pentagonal or the like. The sidewall 130 may have an inner surface 132, an outer surface 134 and/or the like. The inner surfaces 122 and 132 of the bottom wall 120 and sidewall 130 may define the holding space of the measuring cup 100.

The spout 150 may be provided at a front portion of the measuring cup 100 and at an upper portion of the wall structure 110 and. The spout 150 may project outwardly from an upper front portion of the sidewall 130. The handle 160 may arranged at the opposite side of the spout 150. The handle may be connected to an upper portion of the sidewall 130 and bent downwardly in a diagonal direction with respect to the bottom wall 120.

The surface pattern 200 may be formed on the wall structure 110 to function as a visually observable indicative sign of a volume of the content contained within the holding space of the measuring cup 100. The surface pattern 200 may occupy a limited portion of the wall structure 110, such as, e.g., the front portion of the sidewall 130 as shown in FIGS. 1-6. However, the surface pattern 200 may be located on another portion or portions of the sidewall 130 or occupy the entire sidewall 130. The surface pattern 200 may include at least one of an inner surface pattern 210, an outer surface pattern 250 and/or the like. For example, when the sidewall 130 is transparent or translucent, the surface pattern 200 may be formed on either or both of the inner and outer surfaces 132, 134 of the sidewall 130. However, when the sidewall 130 is opaque, the surface pattern 200 may include the inner surface pattern 210 only.

FIG. 2 shows a top view of the measuring cup 100 shown in FIG. 1. The top view of the measuring cup 100 may be symmetrical with respect to line A-A′. However, an asymmetrical configuration is also contemplated. The opening 140 of the measuring cup 100 may have an oval or tear-drop shape. The upper surface 132 of the bottom wall 130 may have a substantially circular shape. Other shapes are contemplated for the opening 140 and the bottom wall 130. The opening 140 may be larger than the upper surface 122 of the bottom wall 120. The sidewall 130 may taper from the opening 140 to the bottom wall 120, thereby forming a trapezoid shape when viewed from the sides thereof as shown in FIGS. 3, 4 and 6. The front portion of the opening 140 may be further stretched outwardly such that the inner surface 132 at the front portion of the measuring cup 100 may be larger than that of the rear and side portions of the measuring cup 100.

The inner surface pattern 210 may at least partially occupy the inner surface 132 of the sidewall 130. For example, the inner surface 210 may occupy the front portion of the measuring cup 100 as shown in FIG. 2. The inner surface pattern 210 may include a plurality of concave patterns 220. Each of the concave patterns 220 may be vertically concave such that top and bottom edges thereof may be curved out. The concave patterns 220 may be horizontally concave to conform to the curved inner surface 132 of the sidewall 130 as shown in FIG. 2. When the concave patterns 220 are formed on a flat surface, the concave patterns 220 may also be horizontally flat.

The concave patterns 220 may be arranged in or on the inner surface 132 of the sidewall 130. The concave patterns 220 may include first, second, third, fourth concave patterns 222, 224, 226, 228, a partial concave pattern 240, and/or the like. The first concave pattern 222 may be superposed on the inner surface 132 of the bottom wall 130. The second concave pattern 224 may be arranged on the concave pattern 222. The third concave pattern 226 is arranged on the second concave pattern 224. The fourth concave pattern 228 may be arranged on the third concave pattern 226. The partial concave pattern 240 may be arranged on the fourth concave pattern 228. The partial concave pattern 240 may have only one protruded edge at the bottom portion thereof. The top portion of the partial concave pattern 240 may transition seamlessly to the upper edges of the sidewall 110 and the spout 150.

Each concave pattern 220 may be indicative of a predetermined volume (e.g., one cup, a half cup, one ounce, four ounces or the like) within the measuring cup 100. For example, the first concave pattern 222 corresponds to one cup, the combination of the first and second concave patterns 222, 224 may correspond to two cups, and the combination of the first, second, third and fourth concave patterns 222, 224, 226, 228 may correspond to four cups. Of course, other volume amounts are contemplated. Although FIG. 2 shows the concave patterns 220 including four concave patterns 222, 224, 226, 228, the number of the concave patterns 220 may be increased or reduced depending on the capacity of the measuring cup 100, the measurement unit which the concave patterns 220 are intended to indicate, and/or the like. For example, a measuring cup with a larger capacity may have more concave patterns compared to a measuring cup with a smaller capacity. Also, for the same capacity, a cup for measuring ounces may have more concave patterns than a cup for measuring cups may have because one cup is equivalent to eight ounces.

As mentioned above, the concave patterns 220 may be vertically concave such that top and bottom edges thereof may be curved out and protrude. By superposing the concave patterns 220, the protruded edges between the concave patterns 220 may form a plurality of visually observable horizontal lines 230. The protruded horizontal lines 230 may include horizontal lines 232, 234, 236, 238 and/or the like. The horizontal line 232 may be formed by the protruded edge between the concave patterns 222, 224. The horizontal line 234 may be formed by the protruded edge between the concave patterns 224, 226. The horizontal line 236 may be formed by the protruded edge between the concave patterns 226, 228. The horizontal line 238 may be formed by the protruded edge between the concave pattern 228 and the partial concave pattern 240. Although, FIG. 2 shows four horizontal lines 232, 234, 236, 238, the number of the horizontal lines 230 may vary depending on the number of the concave patterns 220 formed on the inner surface 132 of the sidewall 130.

The protruded horizontal lines 230 may be indicative of the predetermined volumes within the holding space of the measuring cup 110. For example, the first horizontal line 232 corresponds to one cup, and the second horizontal line 234 may correspond to two cups. Similarly, the third and fourth horizontal lines 236, 238 may correspond to three and four cups, respectively. The protruded horizontal lines 230 on the inner surface 132 of the sidewall 130 may allow a user to look downwardly into the measuring cup 100 to visually detect the volume level of the contents in the measuring cup 100. This may eliminate the need to look horizontally at the cup at eye level. Furthermore, when the sidewall 130 is transparent or translucent, the user may easily detect the volume level of the contents in the measuring cup 100 from any view point without lifting the measuring cup 100 up to eye level or looking downwardly into the measuring cup 100.

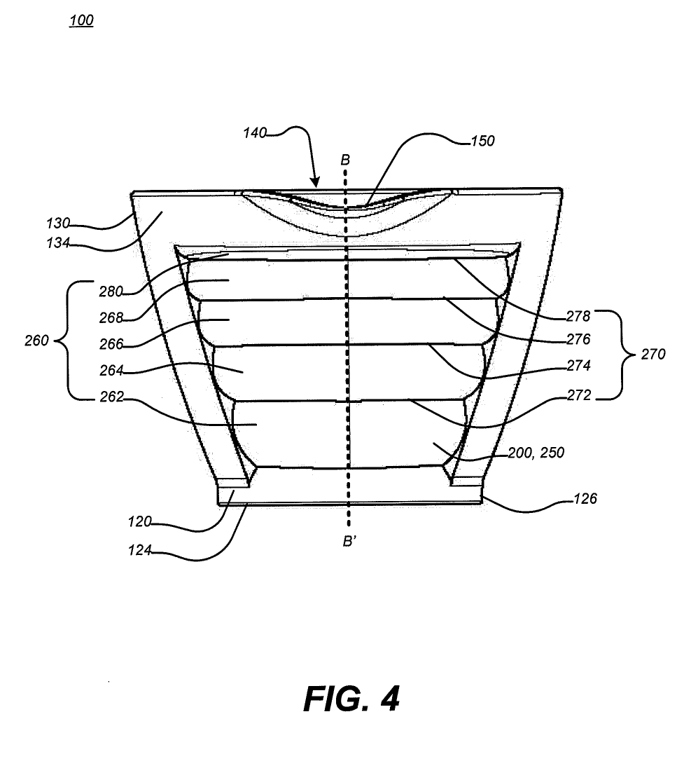

FIG. 3 shows a side view of the measuring cup 100 shown in FIG. 1. FIG. 4 shows a front view of the measuring cup 100 shown in FIG. 1. Referring to FIGS. 3 and 4 concurrently, the surface pattern 200 may include the outer surface pattern 250, which may at least partially occupy the outer surface 134 of the sidewall 130. As shown in FIG. 4, the front view of the measuring cup 100 may be substantially symmetrical with respect to line B-B′ although an asymmetrical configuration is contemplated. The outer surface pattern 250 may include a plurality of convex patterns 260. Each of the convex patterns 260 may be vertically convex such that top and bottom edges thereof may be curved in and/or recessed inwardly. The convex patterns 260 may also be horizontally curved to conform to the curved outer surface 134 of the sidewall 130. However, when the convex patterns 260 are formed with a flat surface, the convex patterns 260 may also be horizontally flat.

The convex patterns 260 may be arranged in or on the outer surface 134 of the sidewall 130. The convex patterns 260 may include first, second, third, fourth convex patterns 262, 264, 266, 268, a partial convex pattern 280, and/or the like. The first convex pattern 262 may be supposed on the bottom wall 130. The second convex pattern 264 may be arranged on the first convex pattern 262. The third convex pattern 266 may be arranged on the second convex pattern 264. The fourth convex pattern 268 may be arranged on the third convex pattern 266. The partial convex pattern 280 may be arranged on the fourth convex pattern 268. The partial convex pattern 280 may have only one recessed edge at the bottom portion thereof. The top portion of the partial convex pattern 280 may transition seamlessly to the upper edges of the sidewall 110 and the spout 150.

Similar to the concave patterns 210 shown in FIG. 2, each convex pattern 260 may be indicative of a predetermined volume within the measuring cup 100. When both the concave and convex patterns 210, 260 are formed on the measuring cup 100, the concave and convex patterns 210, 260 may correspond to each other. For example, both the first concave pattern 222 and the first convex pattern 262 may correspond to the same volume level (e.g., one cup). However, the concave and convex patterns 210 and the convex pattern 260 may be configured to indicate two different sets of volume levels.

As mentioned above, the convex patterns 260 may be vertically convex such that top and bottom edges thereof may be curved in and/or recessed inwardly. By arranging the concave patterns 220 as described and/or shown, the recessed edges between the convex patterns 220 may form a plurality of visually observable horizontal lines 270. The recessed horizontal lines 270 may include horizontal lines 272, 274, 276, 278 and/or the like. The horizontal line 272 may be formed by the recessed edge between the convex patterns 262, 264. The horizontal line 274 may be formed by the recessed edge between the convex patterns 264, 266. The horizontal line 276 may be formed by the recessed edge between the convex patterns 266, 268. The horizontal line 278 may be formed by the recessed edge between the convex pattern 268 and the partial convex pattern 280. The number of the recessed horizontal lines 270 may vary depending on the number of the convex patterns 260 formed on the outer surface 134 of the sidewall 130.

Similar to the protruded horizontal lines 230 shown in FIG. 2, the recessed horizontal lines 270 may be indicative of the predetermined volumes within the holding space of the measuring cup 110. The recessed horizontal lines 270 may allow the user to look downwardly into the measuring cup 100 to visually detect the volume level of the contents in the measuring cup 100. Furthermore, when the sidewall 130 is transparent or translucent, the recessed horizontal lines 270 may allow the user to detect the volume level of the contents in the measuring cup 100 from any view point without lifting the measuring cup 100 up to eye level or looking downwardly into the measuring cup 100. When both the protruded horizontal lines 230 and the recessed horizontal lines 270 are formed on the measuring cup 100, the protruded horizontal lines 230 and the recessed horizontal lines 270 may correspond to each other. For example, both the first protruded horizontal line 232 and the first recessed horizontal line 272 may correspond to the same volume level (e.g., one cup). However, the protruded horizontal lines 230 and the recessed horizontal lines 270 may be configured to indicate two different sets of predetermined volume levels.

The surface pattern 200 may have a different configuration. For example, the surface pattern 200 may be configured such that the inner surface pattern 210 may include a plurality of convex patterns and the outer surface pattern 250 may include a plurality of concave patterns. Alternatively, both the inner and outer surface patterns 210, 250 may include a plurality of concave patterns only or, alternatively, a plurality of convex patterns only. When no surface pattern is formed on the outer surface 134 of the sidewall, the inner surface pattern 210 may include a plurality of concave patterns only or, alternatively, a plurality of convex patterns only. When no surface pattern is formed on the inner surface 132 of the sidewall 130, the outer surface pattern 250 may include a plurality of concave patterns only or, alternatively, a plurality of convex patterns only.

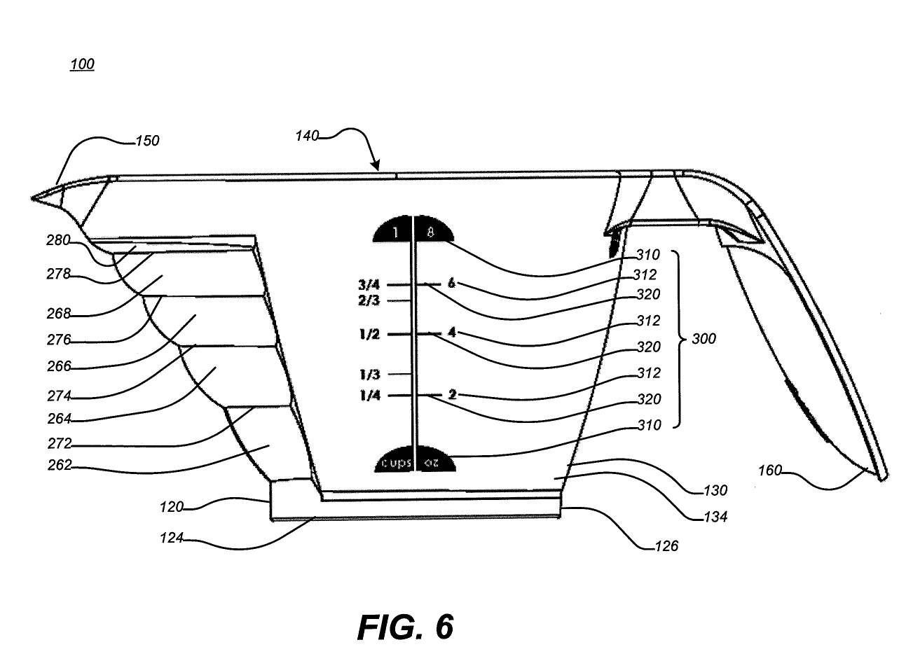

Referring to FIGS. 5 and 6, the measuring cup 100 may include volumetric indicia disposed on the sidewall 130 thereof to provide additional visible indication of volume levels within the holding space of the measuring cup 100. The indicia may be disposed on any portion of the measuring cup. For example, as shown in FIG. 5, volumetric indicia 300 may be disposed on the front portion of the measuring cup 100. In FIG. 6, the volumetric indicia 300 are disposed on a side portion of the measuring cup 100. The indicia 300 may be disposed on more than one portion of the measuring cup 100. For example, the indicia 300 may be disposed on the front portion and both side portions of the measuring cup 100. For a transparent or translucent sidewall 130, the indicia 300 may be disposed on either or both of the inner and outer surfaces 132, 134 of the sidewall 130. The indicia 300 may be formed only on the inner surface 132 for opaque measuring cups.

The indicia 300 may include one or more sets of alphanumeric characters 310, 312, one or more markings 320 and/or the like. The set of alphanumeric characters 310 may be positioned adjacent to the horizontal lines 230 and/or 270 to indicate the volume levels thereof. For example, as shown in FIG. 5, the set of alphanumeric characters 31.0 may includes “¼,” “½,” “¾,” and “1” disposed vertically adjacent to the horizontal lines 272, 274, 276, 278, respectively. The set of alphanumeric characters 310 may further include “cups” to identify the measurement unit for the “¼,” “½,” “¾,” and “1.” The “cup” may be disposed at or near the bottom of the side wall 130. The set of alphanumeric characters 310 may be reversed to appear backwards to the user viewing from the outer surface 134 of the sidewall 130 but may appear normally when the user views downwardly from the inner surface 132 of the sidewall 130.

The markings 320 may be vertically spaced apart from each other to designate different volumes, respectively. The set of markings 320 may not overlap the horizontal lines 230 and/or 270. Instead, the set of markings 320 may be disposed between the horizontal lines 230 and/or 270 to indicate in-between volumes that are between the volumes indicated by the horizontal lines 230 and/or 270. For example, as shown in FIG. 5, one of the markings 320 may be disposed between the horizontal lines 272, 274 to indicate an in-between volume level of a third cup. Another marking 320 may be disposed between the horizontal lines 274, 276 to indicate another in-between volume level of two third cup. Another set of alphanumeric characters 312, such as, e.g., “⅓,” “⅔” and/or the like, may be disposed adjacent to the markings 320 to indicate the volumes levels thereof.

Additionally or alternatively, the indicia 300 may be disposed on one or more portions of the measuring cup 100 where the surface pattern 200 is not located. For example, as shown in FIG. 6, the indicia 300 may be disposed on one side of the measuring cup 100. The indicia 300 may be formed on both sides of the measuring cup 100. Some of the markings 320 may be disposed to designate the volumes, e.g., ¼ cup (i.e., two ounces), ½ cup (i.e., four ounces), ¾ cup (i.e., six ounces), and one cup (i.e., eight ounces). More markings 320 may be disposed to indicate in-between volumes, e.g., ⅓ cup, ⅔ cup and/or the like. The set of alphanumeric characters 312, such as, e.g., “cups,” “¼,” “⅓,” “½,” “⅔,” “¾,” “1” and/or the like may be disposed adjacent to the markings 320 to indicate the volumes thereof. Additional set of alphanumeric characters 312 may be disposed to further designate the markings 320 in a different measurement unit. For example, FIG. 6 shows the markings 320 designated by the alphanumeric characters “cups,” “¼,” “½,” “¾,” and “1” may be designated by additional alphanumeric characters “oz,” “2,” “4,” “6,” and “8,” respectively. The markings 320 may be arranged so as to be viewed by the user from the side. However, they may be arranged backwards so as to be viewed from the inside.

According to the disclosure, the measuring cup is provided with visually distinctive protruded or recessed lines. Thus, a user may intuitively recognize a volume of contents contained within the measuring cup as the contents are added to the holding space thereof because the contents may cover the protruded or recessed lines formed by a surface pattern without the need to stoop down to the vertical level of the measuring cup or lift the measuring cup to eye level. Thus, the measuring cup of the discloser may be easier and more accurate to use in any situation.

While the disclosure has been described in terms of exemplary embodiments, those skilled in the art will recognize that the disclosure can be practiced with modifications in the spirit and scope of the appended claims. These examples given above are merely illustrative and are not meant to be an exhaustive list of all possible designs, embodiments, applications or modifications of the disclosure.

What is claimed is:

1. A measuring cup comprising:
a wall structure surrounding a holding space to hold contents;
an opening exposing the holding space; and
a surface pattern provided on the wall structure and comprising a plurality of concave patterns superposed on each other, each concave pattern being vertically concave such that edges therebetween are protruded to form a plurality of first visually observable lines indicative of a first set of predetermined volumes within the holding space.

2. The measuring cup of claim 1, wherein the wall structure comprises:
a bottom wall having inner and outer surfaces; and
a sidewall extending upwardly from a circumference of the bottom wall and having inner and outer surfaces,
wherein the holding space is defined by the inner surfaces of the bottom wall and the sidewall.

3. The measuring cup of claim 2, wherein the surface pattern at least partially occupies the sidewall.

4. The measuring cup of claim 3, wherein the plurality of concave patterns occupy a portion of the inner surface of the sidewall in the front portion of the measuring cup.

5. The measuring cup of claim 4, wherein the surface pattern further comprises a plurality of convex patterns, each convex pattern being vertically convex such that edges therebetween are recessed to form a plurality of second visually observable lines indicative of a second set of predetermined volumes, respectively, within the holding space.

6. The measuring cup of claim 5, wherein the plurality of convex patterns occupy a portion of the outer surface of the sidewall in the front portion of the measuring cup.

7. The measuring cup of claim 6, wherein the first and second sets of predetermined volumes are identical.

8. The measuring cup of claim 6, wherein each concave pattern is horizontally curved in at a center thereof, and each convex pattern is horizontally curved out at a center thereof.

9. The measuring cup of claim 2, further comprising:
a spout provided on a front portion of the measuring cup and projecting outwardly from an upper end of the sidewall; and
a handle provided on a rear portion of the measuring cup and connected to the sidewall.

10. The measuring cup of claim 1, further comprising indicia indicating the first set of predetermined volumes.

11. The measuring cup of claim 10, wherein the indicia comprises a first set of alphanumeric characters positioned adjacent to the plurality of first visually observable lines, respectively.

12. The measuring cup of claim 11, wherein the indicia further comprises:
at least one marking spaced between the plurality of first visually observable lines to indicate a predetermined volume between the first set of predetermined volumes; and
at least one second set of alphanumeric characters positioned adjacent to the at least one marking to indicate the predetermined volume thereof.

13. A measuring cup comprising:
a wall structure defining a holding space for containing contents;
an opening exposing the holding space; and
a surface pattern at least partially occupying the wall structure and comprising either or both of a concave pattern group and a convex pattern group,
wherein the concave pattern group comprises a plurality of concave patterns arranged on each other, each concave pattern being vertically concave such that edges therebetween are protruded to form a plurality of first visually observable lines indicative of a first set of predetermined volumes, respectively, within the holding space,
wherein the convex pattern group comprising a plurality of convex patterns arranged on each other, each convex pattern being vertically convex such that edges therebetween are recessed to form a plurality of second visually observable lines indicative of a second set of predetermined volumes, respectively, within the holding space.

14. The measuring cup of claim 13, wherein the first and second sets of the predetermined volumes are identical.

15. The measuring cup of claim 13, the wall structure comprises:
a bottom wall having inner and outer surfaces; and
a sidewall expending upwardly from a circumference of the bottom wall and having inner and outer surfaces,
wherein the holding space is defined by the inner surfaces of the bottom wall and the sidewall.

16. The measuring cup of claim 15, wherein the surface pattern at least partially occupies a front portion of the measuring cup.

17. The measuring cup of claim 16, wherein the concave pattern group occupies the inner surface of the sidewall in the front portion of the measuring cup.

18. The measuring cup of claim 16, wherein the convex pattern group occupies the outer surface of the sidewall in the front portion of the measuring cup.

19. The measuring cup of claim 15, further comprising:
a spout provided in the front portion of the measuring cup and projecting outwardly from an upper end of the sidewall; and
a handle provided on a rear portion of the measuring cup and connected to the sidewall.

20. The measuring cup of claim 15, further comprising indicia positioned adjacent to at least one of the first and second sets of predetermined volumes.
